(19) United States
(12) Patent Application Publication
(10) Pub. No.: US 2022/0029518 A1
(43) Pub. Date: Jan. 27, 2022

(54) ORBITAL MAGNETIC GEARS, AND RELATED SYSTEMS

(71) Applicant: OCEANA ENERGY COMPANY, Washington, DC (US)

(72) Inventor: Kent DAVEY, Lebanon, OH (US)

(73) Assignee: OCEANA ENERGY COMPANY, Washington, DC (US)

(21) Appl. No.: 17/299,480

(22) PCT Filed: Dec. 6, 2019
(86) PCT No.: PCT/US2019/064873

§ 371 Date: Jun. 3, 2021

Related U.S. Application Data
(60) Provisional application No. 62/776,673, filed on Dec. 7, 2018.

(51) Int. Cl. H02K 49/10; H02K 7/18; F03B 13/00

(52) U.S. Cl. CPC H02K 49/102; H02K 7/1823; F05B 2240/60; F05B 2240/10; F05B 2240/24; F03B 13/00

(57) ABSTRACT

In accordance with various embodiments of the present disclosure, an orbital magnetic gear includes a gear shaft. The orbital magnetic gear also includes a first stator magnet ring fixed at a. first axial position along the gear shaft and a second stator magnet ring fixed at a second axial position along the gear shaft and adjacent the first stator magnet ring. The orbital magnetic gear further includes a rotor magnet ring rotatably coupled to the gear shaft. The rotor magnet ring is canted relative to the gear shaft and to the first and second stator magnet rings.

### CROSS-REFERENCE TO RELATED APPLICATIONS

This application claims priority to U.S. Provisional Patent Application No. 62/776,673, filed Dec. 7, 2018 and entitled “Orbital Magnetic Gears, and Related Systems,” the entire content of which is incorporated by reference herein.

### TECHNICAL FIELD

The present disclosure relates generally to orbital magnetic gears, and related systems, including for example, for use in various hydroelectric energy systems, and more particularly in hydroelectric turbines.

### INTRODUCTION

The section headings used herein are for organizational purposes only and are not to be construed as limiting the subject matter described in any way.

Various embodiments of the present disclosure contemplate a magnetic gear which involves the rotation of magnets in a plane inclined at an angle to the magnets it reacts with, what is sometimes referred to by those of ordinary skill in the art as “out of the plane of the ecliptic.” Magnetic gears can be of the planetary or cycloidal (sometimes referred to has harmonic) type. Conventional cycloidal magnetic gears can achieve a relatively large torque density but some relative challenges with this gear include (1) the requirement to convert cycloidal motion to concentric rotation, and (2) a relatively high centrifugal load on the bearings on the cycloid shaft. Conventional planetary magnetic gears have balanced forces on both sides of the rotation axis but require passive laminated teeth between the magnets that generate the forces.

A need exists to provide a magnetic gear that produces a relatively high torque density, while reducing the centrifugal load on the bearings to increase the life of the bearings. A need further exists to provide a magnetic gear with balanced forces on either side of the rotation axis, but that does not need laminations between magnets.

### SUMMARY

The present disclosure solves one or more of the above-mentioned problems and/or achieves one or more of the above-mentioned desirable features. Other features and/or advantages may become apparent from the description which follows.

In accordance with various exemplary embodiments of the present disclosure, an orbital magnetic gear includes a gear shaft. The orbital magnetic gear also includes a first stator magnet ring fixed at a. first axial position along the gear shaft and a second stator magnet ring fixed at a second axial position along the gear shaft and adjacent the first stator magnet ring. The orbital magnetic gear further includes a rotor magnet ring rotatably coupled to the gear shaft. The rotor magnet ring is canted relative to the gear shaft and to the first and second stator magnet rings.

In accordance with various additional exemplary embodiments of the present disclosure, a hydroelectric turbine includes a stator and a rotor disposed radially outward of the stator, the rotor being rotatable around the stator about an axis of rotation. The hydroelectric turbine also includes a generator disposed along the axis of rotation. The generator is fixedly coupled to the stator. The hydroelectric turbine additionally includes an orbital magnetic gear comprising a rotor magnet ring that is canted relative to the axis of rotation. The orbital magnetic gear being disposed along the axis of rotation and operably coupled to the generator. The hydroelectric turbine further includes a plurality of blades operably coupled to and extending radially outwardly from the orbital magnetic gear. The plurality of blades is fixed to the rotor to rotate the rotor in response to fluid flow interacting with the blades.

Additional objects and advantages will be set forth in part in the description which follows, and in part will be obvious from the description, or may be learned by practice of the present teachings. At least some of the objects and advantages of the present disclosure may be realized and attained by means of the elements and combinations particularly pointed out in the appended claims.

It is to be understood that both the foregoing general description and the following detailed description are exemplary and explanatory only and are not restrictive of the present disclosure and claims, including equivalents. It should be understood that the present disclosure and claims, in their broadest sense, could be practiced without having one or more features of these exemplary aspects and embodiments.

### BRIEF DESCRIPTION OF THE DRAWINGS

The accompanying drawings, which are incorporated in and constitute a part of this specification, illustrate some exemplary embodiments of the present disclosure and together with the description, serve to explain certain principles. In the drawings

FIG. 1A is an enlarged, perspective view of an exemplary embodiment of a cylindrical bearing surface in accordance with the present disclosure;

FIG. 1B illustrates an exemplary embodiment of a gear shaft having multiple cylindrical bearing surfaces in accordance with the present disclosure;

FIG. 2 is an exploded view of an exemplary embodiment of an orbital magnetic gear in accordance with the present disclosure;

FIG. 3 is a partial, enlarged view of an exemplary embodiment of an output drive of the orbital magnetic gear of FIG. 2;

FIG. 4A illustrates a pole pattern when torque on an inner magnet ring of a conventional cycloidal gear is counterclockwise;

FIG. 4B illustrates a pole pattern when torque on the inner magnet ring of the conventional cycloidal gear of FIG. 4A is clockwise;

FIG. 5A is a side, cross-sectional view of the orbital magnetic gear of FIG. 2 in a first rotational position;

FIG. 5B is a side, cross-sectional view of the orbital magnetic gear of FIG. 2 in a second rotational position;

FIG. 6 is a perspective, cross-sectional view of the orbital magnetic gear of FIG. 2;

FIG. 7 is a partial, perspective cross-sectional view of the orbital magnetic gear of FIG. 2;

FIG. 8 is a side, cross-sectional view of another exemplary embodiment of an orbital magnetic gear in accordance with the present disclosure;

FIG. 9 is a graph illustrating torque output as a function of a separation distance of outer magnet rings of an orbital magnetic gear in accordance with the present disclosure;

FIGS. 10A-10C progressively illustrate the rotary motion of the orbital magnetic gear of FIG. 2;

FIGS. 11A-11C progressively illustrate the wobble motion of the orbital magnetic gear of FIG. 2;

FIG. 12A illustrates a pole pattern when torque on an inner magnet ring of the orbital magnetic gear of FIG. 2 is counterclockwise;

FIG. 12B illustrates a pole pattern when torque on the inner magnet ring of 12A

FIG. 13 is a cross-sectional view of a hydroelectric turbine in accordance with the present disclosure.

### DESCRIPTION OF EXEMPLARY EMBODIMENTS

Orbital magnetic gears in accordance with exemplary embodiments of the present disclosure may achieve relatively high torque densities, for example, on the order of conventional magnetic cycloidal gears, while substantially reducing bearing load issues often experienced by magnetic cycloidal gears. Unlike conventional magnetic cycloidal gears, the disclosed orbital magnetic gears may, for example, balance the forces on the bearings on either side of the rotation axis, thereby increasing the life of the bearings along the gear shaft (i.e., the L10 life of the bearings).

### Structure of Orbital Magnetic Gear

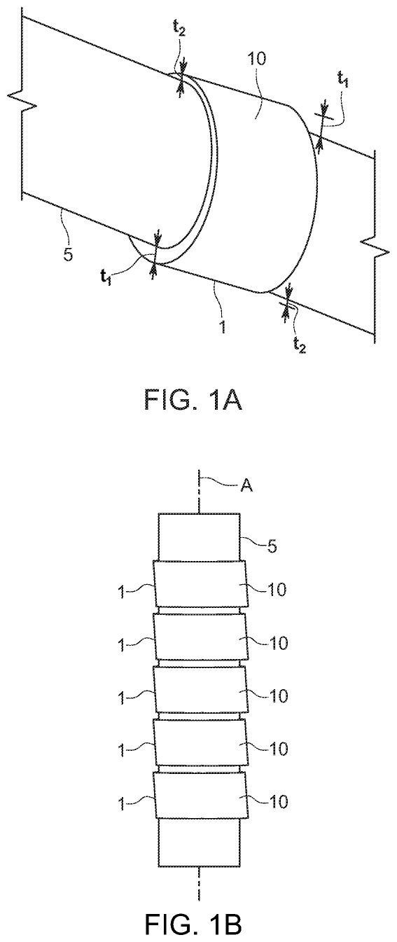

As illustrated in FIGS. 1A and 1B, orbital magnetic gears (OMGs) in accordance with exemplary embodiments of the present disclosure utilize a gear shaft 5 having one or more bearing surfaces 1 that are configured to receive and support a cylindrical bearing on the gear shaft 5. As best illustrated in FIG. 1B, the one or more bearing surfaces 1 (five bearing surfaces 1 being shown in the embodiment of FIG. 1B) are aligned at a slight angle relative to an axis A of the gear shaft 5. In other words, each bearing surface 1 has an outer surface 10 that is inclined in a plane relative to the axis A of the gear shaft 5. In one embodiment, for example, the bearing surfaces 1 are machined directly into the gear shaft 5 at an angle, such that a thickness t₁ of each bearing surface 1 is greater than a thickness t₂ of the bearing surface 1. For example, as shown in FIG. 1A, the thickness of each bearing surface 1 varies between thicknesses t₁ and t₂ both circumferentially and axially with respect to the gear shaft 5.

In accordance with various exemplary embodiments, the thickness t₁ may be about 3 times greater than the thickness t₂. For example, in one embodiment, the thickness t₁ is about 3/16^{th} of an inch while the thickness t₂ is about 1/16^{th} of an inch. Those of ordinary skill in the art will understand, however, that the bearing surfaces 1 may have various dimensions, including outer surfaces 10 having various inclinations relative to the axis A formed by various thicknesses t₁ and t₂, and be formed by various methods and techniques, without departing from the present disclosure and claims.

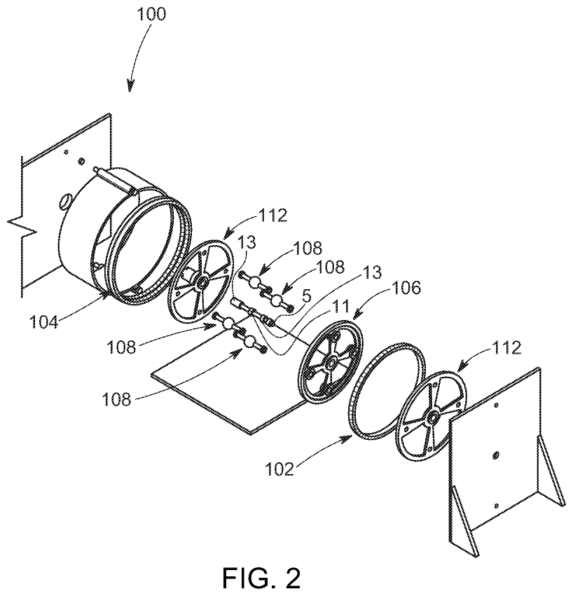

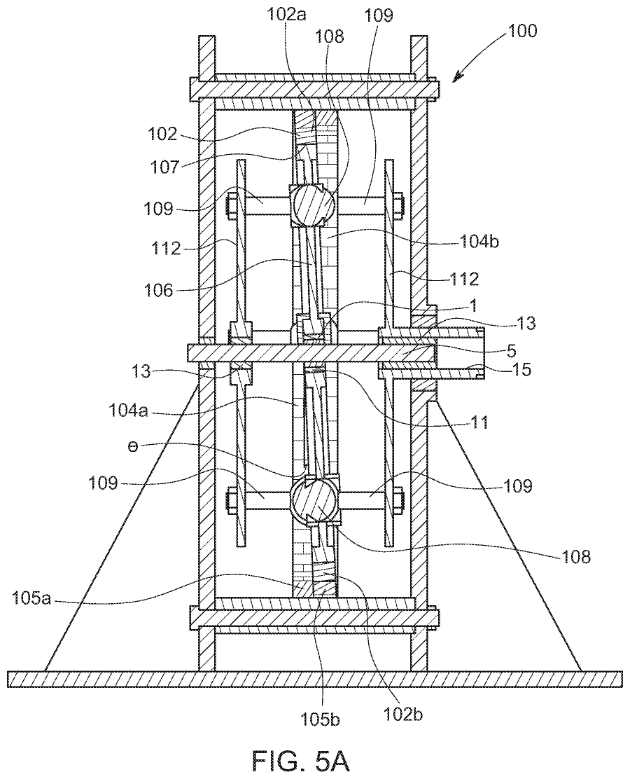

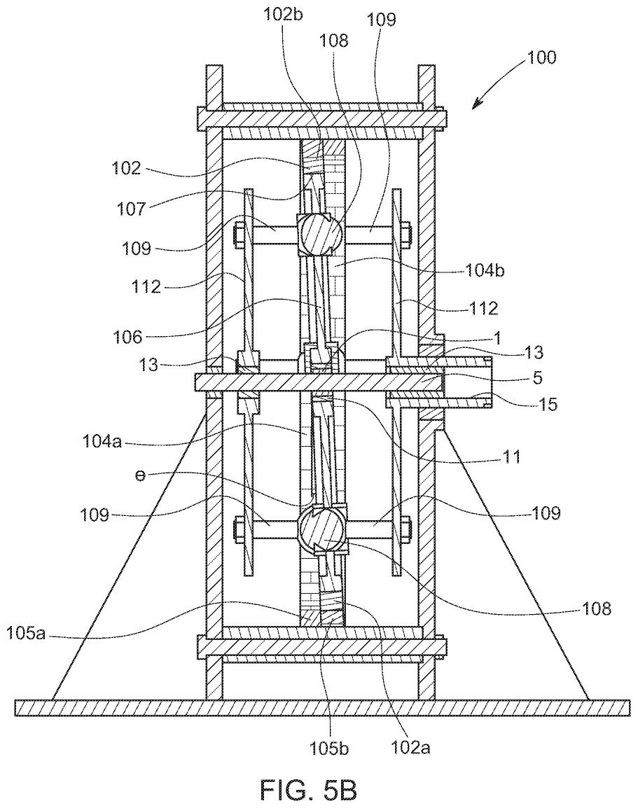

As will be described further below, in accordance with one exemplary embodiment of an OMG having a single rotor magnet ring, the inclination of a single bearing surface 1 allows a cylindrical bearing 11, which is supported by the bearing surface 1 (see FIGS. 2, 5A, 5B, and 6), to support the rotor magnet ring (e.g., an inner magnet ring) in a canted position relative to the gear shaft 5 and to a pair of stator magnetic rings (e.g., outer magnet rings). In accordance with various exemplary embodiments of the present disclosure, the inclination of the bearing surface 1 may support the rotor magnet ring at a cant angle θ (see FIGS. 5A and 5B) of less than about 15 degrees relative to the stator magnet rings, such as, for example, less than about 10 degrees relative to the stator magnet rings. In this manner, as will be described further below, a first portion of the rotor magnet ring is diametrically opposed to a second portion of the rotor magnet ring about the axis A of the gear shaft 5, and the magnets of the rotor magnet ring rotate in a plane that is inclined at an angle relative to the magnets of the stator magnet rings, thereby providing for motion that is “out of the plane of the ecliptic.” Those of ordinary skill in the art would understand that OMGs in accordance with the present disclosure contemplate supporting the rotor magnet ring at various cant angles 8 relative to the stator magnet rings depending upon a size and application of the OMG. For example, the cant angle θ is inversely proportional to a diameter of the OMG (i.e., diameters of the rotor and stator rings). In other words, the smaller the diameter of the OMG, the larger the required cant angle θ.

Further, in various embodiments, an OMG which utilizes a single tilted bearing surface to incline (i.e., can't) a single rotor magnet ring (e.g., inner magnet ring) may require about 33% more magnets than its cycloidal counterpart. And, an OMG with two tilted bearing surfaces to respectively incline two inner magnet rings, may require about 20% more magnets than its cycloidal counterpart. Although not wishing to be bound by a particular theory, the inventors have found that, with n surfaces, the additional magnet requirement for an OMG may be characterized as:

$$\% add ' l magnets = 100 * \frac{1}{2 n + 1} \qquad ( 1 )$$

An exemplary embodiment of an OMG 100 having a single rotor magnet ring, a single inner magnet ring 102, is illustrated in FIGS. 2-7. As shown best perhaps in FIGS. 5A and 5B, the OMG 100 includes a first outer magnet ring 104a fixed at a first axial position along a gear shaft 5 and a second outer magnet ring 104b fixed at a second axial position along the gear shaft 5 and adjacent to the first outer magnet ring 104a. The inner magnet ring 102 is rotatably coupled to the gear shaft 5 and disposed radially within a space bounded by the first and second outer magnet rings 104a and 104b. As further illustrated in FIGS. 5A and 5B, the inner magnet ring 102 is canted relative to the gear shaft 5 and the first and second outer magnet rings 104a and 104b. The inner magnet ring 102 is configured to rotate inside the two fixed outer magnet rings 104a and 104b via an output drive hub 106. The output drive hub 106, for example, is positioned radially within the inner magnet ring 102, such that the inner magnet ring 102 extends around an outer circumference 107 of the output drive hub 106. A cylindrical bearing 11, which is supported, for example, on the cylindrical bearing surface 1 described above with reference to FIGS. 1A and 1B, is configured to support the output drive hub 106 on the gear shaft 5 and allow rotation of the inner magnet ring 102 with respect to the gear shaft 5. In this manner, during rotation of the inner magnet ring 102, the output drive hub 106 undergoes a wobble motion (i.e., a precession motion) due to the inclined outer surface 10 of the cylindrical bearing surface 1.

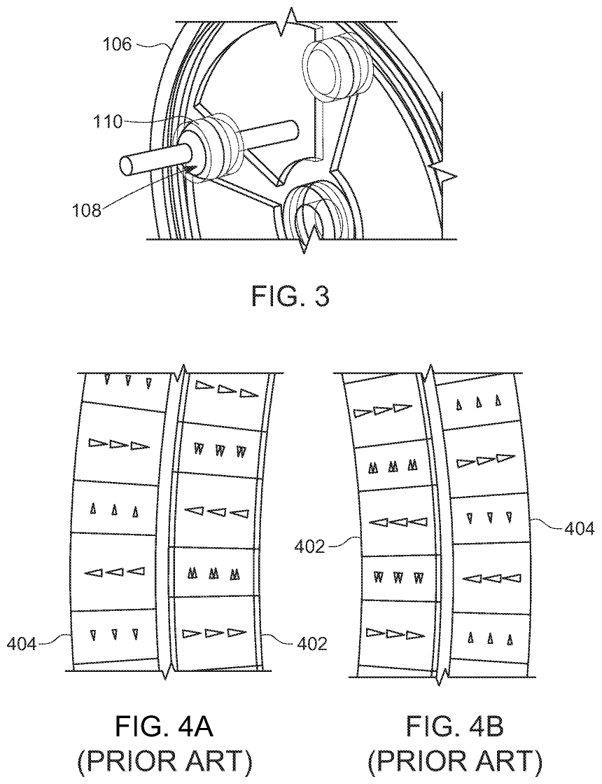

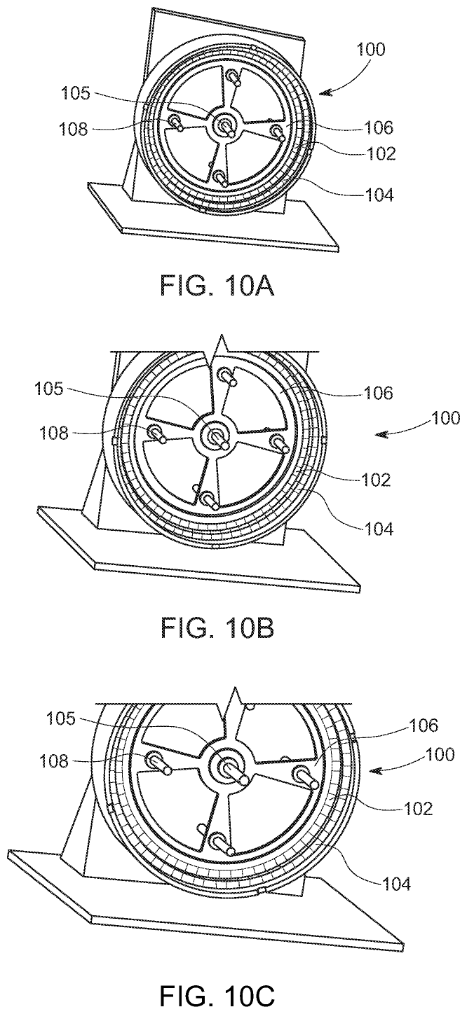

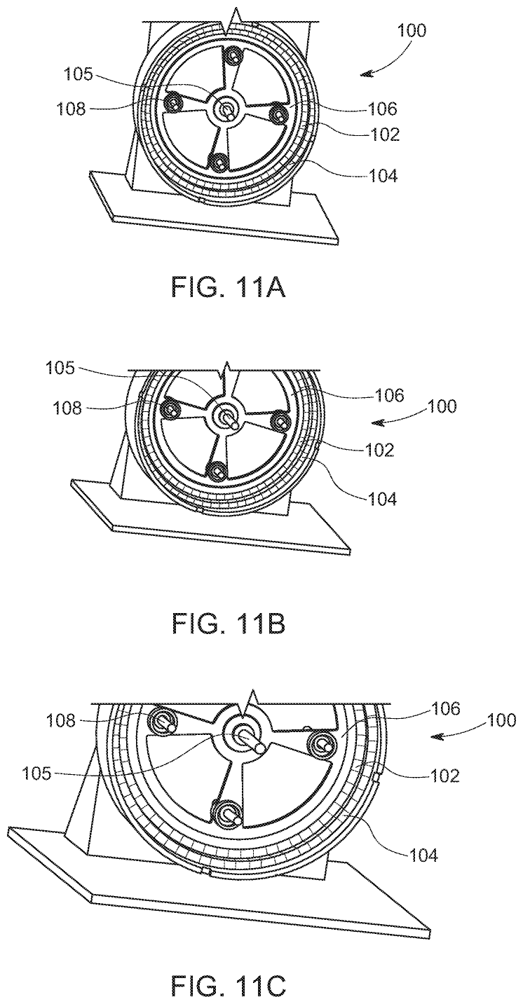

As shown in FIGS. 10A-100 and 11A-110, the output drive hub 106 undergoes a wobble motion (see FIGS. 11A-110) combined with a rotation (see FIG. 10A-100). As shown in FIG. 3, in various embodiments, for example, the output drive hub 106 includes one or more spherical sockets 110 that are configured to receive a respective spherical bearing/linear bushing 108. With reference to FIGS. 5-7, in one exemplary embodiment, the output drive hub 106 includes four spherical sockets 110 that are spaced at equal intervals around a circumference of the output drive hub 106. When the OMG 100 is assembled, each spherical socket 110 holds a respective spherical bearing/linear bushing 108, such that ends 109 of the bushing 108 extend between and are affixed to a pair of stabilizing rings 112, which are supported, for example, on the gear shaft 5 via bearings 13. In this manner, the spherical bearings/linear bushings 108 allow for the wobble motion of the output drive hub 106, while transferring the rotation of the output drive hub 106 to the gear shaft 5.

Those of ordinary skill in the art would understand that the orbital magnetic gear 100 illustrated in FIGS. 2-7 is exemplary only, and that such gears may have various configurations, dimensions, shapes, and/or arrangements of components, including various numbers and/or configurations of inner magnet rings at various cant angles, without departing from the scope of the present disclosure and claims. Furthermore, although the illustrated exemplary embodiment of the OMG 100 utilizes spherical bearing/linear bushings, which are affixed to stabilizing rings, the present disclosure contemplates stabilizing the gear, while allowing a wobble motion of the output drive hub, by any known methods and/or techniques.

Although not illustrated in the present disclosure, those of ordinary skill in the art would additionally understand that the disclosed principles may also be applied to an embodiment in which the positioning of the stator and rotor magnet rings is reversed. For example, the present disclosure further contemplates an OMG having a single rotating outer magnet ring that is canted relative to two fixed inner magnet rings. In such an embodiment, the OMG includes a rotor magnet ring rotatably coupled to the gear shaft (i.e., an outer magnet ring), a first stator magnet ring (i.e., a first inner magnet ring) fixed at a first axial position along the gear shaft, and a second stator magnet ring (i.e., a second inner magnet ring) fixed at a second axial position along the gear shaft and adjacent the first stator magnet ring. And, the first and second stator magnet rings are disposed radially within a space bounded by the rotor magnet ring.

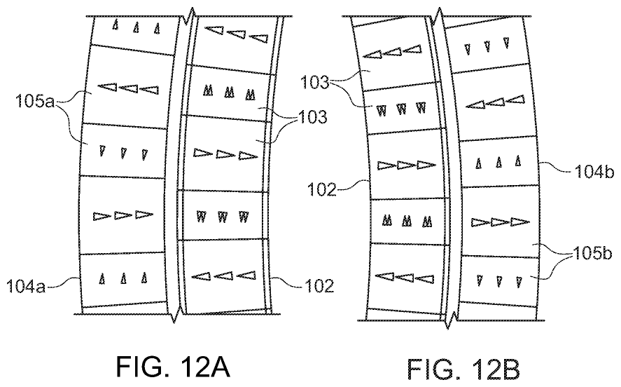

OMGs in accordance with the present disclosure may utilize various combinations of magnets on the inner and outer magnet rings in order to produce a desired gear ratio. As illustrated for example in FIGS. 12A and 12B, the present disclosure contemplates that the first outer magnet ring 104a is formed from a first set of magnets 105 (e.g., 105a), the second outer magnet ring 104b is formed from a second set of magnets 105 (e.g., 105b), and the inner magnet ring 102 is formed from a third set of magnets 103. In accordance with one exemplary embodiment, each of the first and second sets of magnets 105 have two more poles than the third set of magnets 103. In other words, the magnets 103 and 105 on the inner and outer magnet rings 102 and 104 of the OMG 100 are configured such that there are two more poles Nₛ on each of the outer magnet rings 104 (i.e., 104a and 104b) than on the inner magnet ring 102, which has Nᵣ poles. With this magnetic arrangement, the gear ratio of the OMG 100 is:

$$ratio = \frac{Nr}{N s - N r} \qquad ( 2 )$$

The magnetic poles can be arranged on the concentric rings of the inner and outer magnet rings 102 and 104 in order to produce a desired torque. For example, in a conventional cycloidal magnetic gear in which there are two more poles on an outer magnet ring 404 (i.e., a stator ring) than on an inner magnet ring 402 (i.e., a rotor ring), the poles may be positioned such that they generate a clockwise torque on the inner magnet ring 402 at a 3 o'clock position (see FIG. 4B). However, since there are two more poles on the outer magnet ring 404 than the inner magnet ring 402, this pole pattern will then generate a counterclockwise torque at a 9 o'clock position (see FIG. 4A). As is understood in the art, one way to attempt address this issue (i.e. of the opposing torques on the concentric rings) is to provide a relatively small radial air gap between the rings on one side of the gear and a relatively large radial air gap between the rings on the opposite side of the gear (i.e., at a rotation of about 180° away from the small gap). However, in such a configuration, the magnets of the inner magnet ring 402 are being constantly pulled towards the place where the air gap is small, thereby still causing a torque imbalance with a pull to one side of the gear. The opposing torques that are generated by the rings can put relatively significant wear on the bearings of the gear, which in turn can lead to the bearings of a conventional magnetic cycloidal gear having a relatively short life (i.e., a short L10 life) and premature failure of the gear.

One way to avoid this issue, as contemplated by the present disclosure, is to use an orbital magnetic gear (OMG) with a canted rotor magnetic ring, such as, for example, a canted inner magnet ring 102 and two stator magnet rings, such as, for example, two outer magnet rings 104 (e.g., 104a and 104b). In this manner, as illustrated in FIGS. 5A and 5B, a first portion 102a of the inner magnet ring 102 is diametrically opposed to a second portion 102b of the inner magnet ring 102 about the axis A of the gear shaft 5. In such a configuration, in a first rotation position of the inner magnet ring 102 about the gear shaft 5 (see FIG. 5A), the first portion 102a of the inner magnet ring 102 is configured to align with the first outer magnet ring 104a and the second portion 102b of the inner magnet ring 102 is configured to align with the second outer magnet ring 104b. And, as illustrated in FIG. 5B, in a second rotation position of the inner magnet ring 102 about the gear shaft 5 (see FIG. 5B), which is about 180 degrees from the first rotation position, the second portion 102b of the inner magnet ring 102 is configured to align with the first outer magnet ring 104a and the first portion 102a of the inner magnet ring 102 is configured to align with the second outer magnet ring 104b. In other words, in the first rotation position of the inner magnet ring 102, the first portion 102a is positioned circumferentially within the first outer magnet ring 104a and the second portion 102b is positioned circumferentially within the second outer magnet ring 104b. And, after the inner magnet ring 102 rotates about 180 degrees, in the second rotation position of the inner magnet ring 102, the first and second portions 102a and 102b switch positions, such that the first portion 102a is now positioned circumferentially within the second outer magnet ring 104b and the second portion 102b is now positioned circumferentially within the first outer magnet ring 104a.

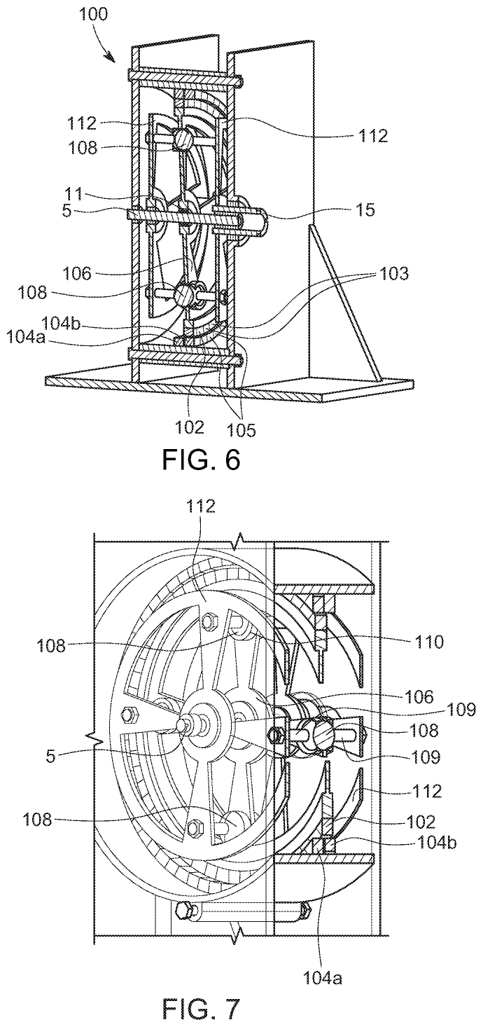

In other words, the present disclosure contemplates that a cant angle of the inner magnet ring 102 may be chosen to overlap with the first outer magnet ring 104a at a top portion of the OMG 100 and the second outer magnet ring 104b at a bottom portion of the OMG 100 (e.g., when the OMG 100 is oriented as shown in FIGS. 5A and 5B). In the orientation of the embodiment of FIGS. 2-7, the inner magnet ring 102 is therefore slanted so that the inner magnet ring 102 aligns substantially with the first outer magnet ring 104a at the top of the OMG 100 and the second outer magnet ring 104b at the bottom of the OMG 100. As further illustrated in FIG. 6, at the same time, the magnet polarity of the magnets 105 of the outer magnet rings 104a and 104b is generally opposite one another for each set of adjacent magnets 105.

As illustrated in FIGS. 12A and 12B, in such a configuration, the inner magnet ring 102 can interact with two different outer magnet rings 104a and 104b rather than only one stator magnet ring to get its net torque, thus eliminating the opposing torques generated in the conventional cycloidal gear as illustrated in FIGS. 4A and 4B. The bearings of OMGs in accordance with the present disclosure, therefore, may exhibit a greater L10 life than the bearings of their conventional cycloidal counterparts.

Torque Performance of the Orbital Magnetic Gear

To test the performance of the disclosed orbital magnetic gears, a planetary and a cycloidal gear were modeled (both computationally in a finite element program and subsequently as a solid model in solid works) and compared against an analytically modeled OMG, as illustrated in FIG. 2, for torque generation. In the comparison, it was assumed that the magnetic gears each had the same overall diameter and magnet utilization. The gears were compared in a 24″ diameter shell, with a 1″ in depth.

The below table summarizes a computational comparison of the various modeled gears.

| | Gear | Air gap | | Torque |
|---|---|---|---|---|
| Gear Type | ratio | (inches) | Magnets | (ft-lbs) |
| Planetary | 30:1 | 0.1 | ¾″ _{SmCo}32 MGO | 358 |
| (60 pole:2 pole) | | | | |
| Planetary | 15:1 | 0.1 | ¾″ _{SmCo}32 MGO | 517 |
| (60 pole:4 pole) | | | | |
| Cycloidal | 30:1 | 0.1 | ¾″ _{SmCo}32 MGO | 877 |
| (62 pole:60 pole) | | | | |
| Orbital | 30:1 | 0.1 | ¾″ _{SmCo}32 MGO | 1052 |
| (62 pole:60 pole, 1 | | | | |
| Orbital | 30:1 | 0.1 | ¾″ _{NdFeB}45 MGO | 1584 |
| (62 pole:60 pole, 1 | | | | |
| Orbital | 30:1 | 0.05 | ¾″ _{NdFeB}45 MGO | 1923 |
| (62 pole:60 pole, 1 | | | | |

As illustrated by the above table, the orbital magnetic gears in accordance with the present disclosure delivered increased torque output compared with the planetary and cycloidal magnetic gears. Moreover, the difference in centrifugal and magnetic loads on the gear compared to the gear with the next highest output, the cycloidal gear, were found to be insignificant.

As discussed above, an OMG in accordance with the present disclosure was found to generally use about 33% more magnet volume for a system having one inner magnet ring and about 20% more magnets for a system having two inner magnet rings. This would suggest that the cycloid torque should be listed as 1.3333·877=1166 ft-lbs (instead of 877 ft-lbs) when comparing against an OMG with only one inner magnet ring and 1.2·877=1052 (instead of 877 ft-lbs) when comparing against an OMG with two inner magnet rings. It was, therefore, determined that the two gear types, cycloidal and OMG, are generally close in performance, with the OMG having bearing loads that are significantly reduced compared to the cycloidal gear.

Furthermore, as would be understood by those of ordinary skill in the art, it is difficult to realize large gear ratios with planetary magnetic gears. Large gear ratios are often attempted, for example, using a high pole count on the outer member and a small pole count on the inner member. The high pole count on the outer member means that less of the flux will go all the way across the two air gaps to the inner member. There also remains the difficulty of sandwiching a passive lamination stack between the two members with sufficient structural integrity to operate under the full load capacity. Assembly can also be more difficult, and the part count can be high if many rotor disks are employed by the planetary magnetic gear.

Increasing the Torque Capability

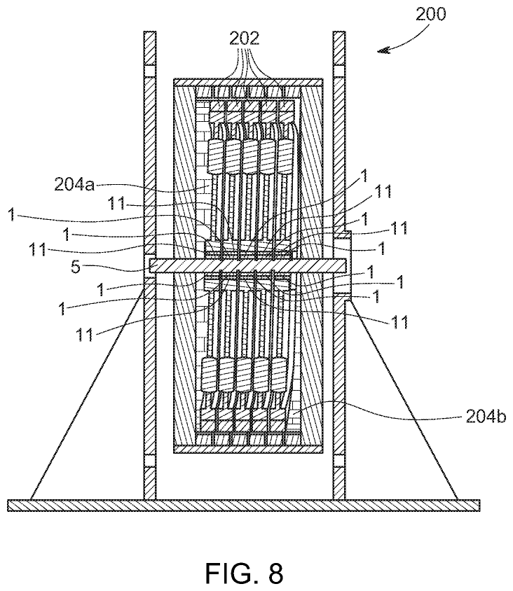

In some applications, devices come with diameter constraints, and the operating length or depth is the usual method for increasing torque. The use of one inner magnet ring with a long depth is possible but may result in about a 33% penalty on magnet volume. Various additional embodiments of the present disclosure, therefore, further contemplate a multi-ring embodiment as illustrated, for example, in FIG. 8. A multi-ring OMG 200, for example, may scale the torque linearly with the number of inner magnet rings 202. As illustrated in FIG. 8, the OMG 200 includes five inner magnet rings 202 rotatably coupled to a gear shaft 5 via respective cylindrical bearings 11, which are supported relative to the gear shaft 5 via respective bearing surfaces 1 (see FIG. 1B). Like the OMG 100, the inner magnet rings 202 are disposed radially within a space bounded by first and second outer magnet rings 204a and 204b and are all canted relative to the gear shaft 5 and the first and second outer magnet rings 204a and 204b. The additional magnet volume required (i.e., compared to a cycloidal gear) for this embodiment will also scale according to equation (1) above.

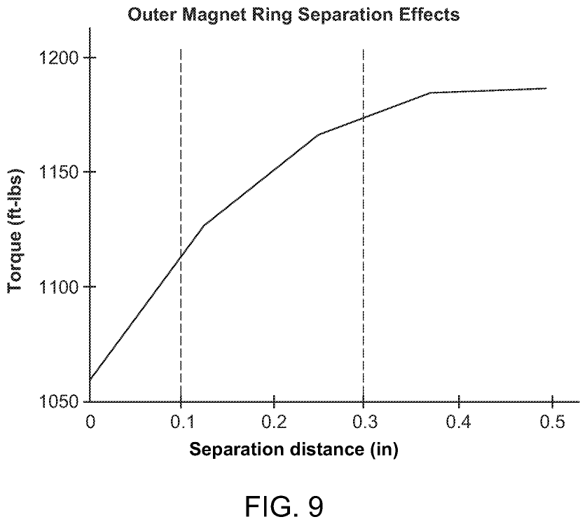

It was found that the separation distance between the first and second outer magnet rings 204a and 204b has minimal effect on the total torque output by the OMG 200. Depending upon the number of inner magnet rings utilized, however, increasing the separation distance between the first and second outer magnet rings 204a and 204b may also necessitate increasing the cant angle of the inner magnet rings 202 (i.e., to ensure that the magnets of the inner magnet rings 202 overlap correctly with the magnets of the outer magnet rings 204a and 204b as discussed above). An OMG in accordance with the present disclosure was also analytically modeled to confirm the effects of separating the outer magnet rings. The conditions of row 4, in the above table, were also assumed for this analysis. As illustrated in the graph of FIG. 9, the change in torque produced by the OMG was slight as the separation distance increased between the outer magnet rings.

Those of ordinary skill in the art will understand that the multi-ring orbital magnetic gear 200 illustrated in FIG. 8 is exemplary only, and that such gears may have various configurations, dimensions, shapes, and/or arrangements of components, including various numbers of inner magnet rings at various cant angles, without departing from the scope of the present disclosure and claims.

Applications in Hydroelectric Energy Systems

Orbital magnetic gears (OMGs) in accordance with the present disclosure may be used in various applications, including, for example, in various hydroelectric energy systems, and more particularly in hydroelectric turbines. The present disclosure contemplates for example, utilizing orbital magnetic gears, such as those illustrated in FIGS. 2-8, in hydroelectric energy systems that include a hydroelectric turbine comprising a stationary member (e.g., a stator) and a rotating member (e.g., a rotor) that is disposed radially outward of an outer circumferential surface of the stator (e.g., is concentrically disposed around the stator) and configured to rotate around the stator about an axis of rotation. Turbines in accordance with the present disclosure can have a plurality of blade portions extending both radially inward and radially outward with respect to the rotor. In this manner, fluid flow having a directional component flow generally parallel to the axis of rotation of the rotor acts on the blade portions thereby causing the rotor to rotate about the axis of rotation.

In accordance with one or more exemplary embodiments of the present disclosure, energy in the fluid flow can be directly converted to electricity using an off the shelf generator that is positioned at a fixed point at the center of the turbine. The generator, for example, may be disposed along the axis of rotation of the turbine and supported relative to the stator to prevent the generator from rotating about the axis of rotation. In accordance with various embodiments, for example, the generator may be disposed within a fixed housing, or pod, that is supported by a support member that interfaces with the stator. In various exemplary embodiments, the support member may include a rim that is coupled to the stator and a plurality of cross angle struts (e.g., spokes) that extend between the rim and the generator housing.

To convert the high torque, low speed power collected by the blades (e.g., from shaft 15 of FIG. 6) to a low torque, high speed input (e.g., from shaft 5 of FIG. 6) suitable for the generator, various embodiments of the present disclosure further contemplate coupling the generator to an orbital magnetic gear as described above. In an exemplary embodiment, as described, for example, in International Application No. PCT/US2019/034306, filed on May 29, 2019, incorporated by reference in its entirety herein, the orbital magnetic gear may be disposed along the axis of rotation between the generator and the radially inward extending blade portions, and the radially inward extending blade portions may terminate at and be affixed to the magnetic gear, such that the radially inward extending blade portions support the orbital magnetic gear at the center of the turbine.

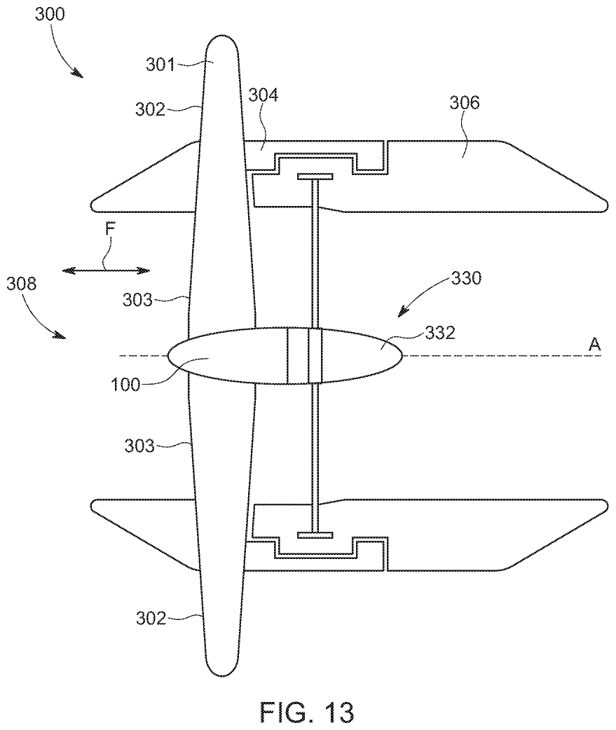

With reference to FIG. 13, an exemplary embodiment of a hydroelectric turbine 300, which utilizes an OMG 100, in accordance with the present disclosure is shown. The hydroelectric turbine 300 includes a rotor 304 disposed radially outward of a stator 306. In this arrangement, a plurality of blades (hydrofoils) 301 can extend radially from proximate a rotational axis A of the rotor 304. Each blade 301 may have a length that extends from proximate a center of the rotor 304 (e.g., from a power takeoff system 330 described further below) to radially beyond the rotor 304 such that a blade portion 303 extends radially inwardly of rotor 304 and a blade portion 302 extends radially outwardly of the rotor 304. In this way, the blades 301 can be arranged to intercept the fluid flow F (schematically designated generally by the arrows in FIG. 13) flowing centrally through the rotor 304 and radially outward of the rotor 304 to thereby cause the rotor 304 to rotate relative to the stator 306 about the central axis of rotation A. In various exemplary embodiments the plurality of blades 301 can be mounted at uniform intervals about the axis of rotation A. However, non-uniform spacing between adjacent blades is also contemplated.

As illustrated in FIG. 13, the blades 301 can be attached toward a front rim of the rotor 304 (i.e., an upstream end of the rotor 304 when the turbine 300 is positioned in the fluid flow F) proximate a first end face 308 of the turbine 300 and can extend radially outward from the centrally located power takeoff system 330. As discussed above, the power takeoff system 330 is disposed along the axis of rotation A of the turbine 300. The power takeoff system 330 includes a generator 332 and an orbital magnetic gear, such as, for example the OMG 100 discussed above, that is coupled to the generator 332. As shown in FIG. 13, the OMG 100 is disposed along the axis of rotation A between the generator 332 and the blades 301. In various embodiments, for example, as above, the blades 301 terminate at and are affixed to the OMG 100. In this manner, the blades 301 support the OMG 100 (i.e., along the central axis of rotation A) and may transfer a high torque, low speed power input to the OMG 100. In turn, the OMG 100 is configured to provide a low torque, high speed power output to the generator 332. As discussed in International Application No. PCT/US2019/034306, incorporated by reference in its entirety herein, the generator 332 is supported relative to the stator 306 to prevent the generator 332 from also rotating about the axis of rotation A. In various embodiments, for example, the generator 332 is a three-phase, high speed, low torque generator, and is disposed within a fixed housing, or pod, having a hydrodynamic profile.

Those of ordinary skill in the art will understand that the hydroelectric energy systems described above are exemplary only and that orbital magnetic gears in accordance with the present disclosure may have various applications and be incorporated into various systems. Due to their relatively small size, various additional embodiments contemplate, for example, incorporating such orbital magnetic gears into wind turbines or high torque density motors. For example, although above exemplary embodiments contemplate utilizing such orbital magnetic gears to covert a high torque, low speed input to a low torque, high speed output, various additional embodiments of the present disclosure contemplate utilizing the disclosed orbital magnetic gears to covert a low torque, high speed input to a low speed, high torque output.

This description and the accompanying drawings that illustrate exemplary embodiments should not be taken as limiting. Various mechanical, compositional, structural, electrical, and operational changes may be made without departing from the scope of this description and the claims, including equivalents. In some instances, well-known structures and techniques have not been shown or described in detail so as not to obscure the disclosure. Furthermore, elements and their associated features that are described in detail with reference to one embodiment may, whenever practical, be included in other embodiments in which they are not specifically shown or described. For example, if an element is described in detail with reference to one embodiment and is not described with reference to a second embodiment, the element may nevertheless be included in the second embodiment.

It is noted that, as used herein, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Further, this description's terminology is not intended to limit the disclosure. For example, spatially relative terms—such as “upstream,” downstream,” “beneath,” “below,” “lower,” “above,” “upper,” “forward,” “front,” “behind,” and the like—may be used to describe one element's or feature's relationship to another element or feature as illustrated in the orientation of the figures. These spatially relative terms are intended to encompass different positions and orientations of a device in use or operation in addition to the position and orientation shown in the figures. For example, if a device in the figures is inverted, elements described as “below” or “beneath” other elements or features would then be “above” or “over” the other elements or features. Thus, the exemplary term “below” can encompass both positions and orientations of above and below. A device may be otherwise oriented (rotated 90 degrees or at other orientations) and the spatially relative descriptors used herein interpreted accordingly.

Further modifications and alternative embodiments will be apparent to those of ordinary skill in the art in view of the disclosure herein. For example, the devices may include additional components that were omitted from the diagrams and description for clarity of operation. Accordingly, this description is to be construed as illustrative only and is for the purpose of teaching those skilled in the art the general manner of carrying out the present disclosure. It is to be understood that the various embodiments shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present disclosure.

It is to be understood that the particular examples and embodiments set forth herein are non-limiting, and modifications to structure, dimensions, materials, and methodologies may be made without departing from the scope of the present disclosure. Other embodiments in accordance with the present disclosure will be apparent to those skilled in the art from consideration of the specification and practice of the invention disclosed herein. It is intended that the specification and examples be considered as exemplary only, with being entitled to their full breadth of scope, including equivalents.

1. An orbital magnetic gear comprising:
a gear shaft;
a first stator magnet ring fixed at a first axial position along the gear shaft;
a second stator magnet ring fixed at a second axial position along the gear shaft and adjacent the first stator magnet ring; and
a rotor magnet ring rotatably coupled to the gear shaft,
wherein the rotor magnet ring is canted relative to the gear shaft and to the first and second stator magnet rings.

2. The orbital magnetic gear of claim 1, wherein the rotor magnet ring is concentrically disposed relative to the first and second stator magnet rings.

3. The orbital magnetic gear of claim 1, wherein the rotor magnet ring is disposed radially within a space bounded by the first and second stator magnet rings.

4. The orbital magnetic gear of claim 3, wherein, in a first rotational position of the rotor magnet ring relative to the gear shaft, a first portion of the rotor magnet ring aligns with the first stator magnet ring and a second portion of the rotor magnet ring aligns with the second stator magnet ring.

5. The orbital magnetic gear of claim 4, wherein, in a second rotational position of the rotor magnet ring about the gear shaft, the second portion of the rotor magnet ring aligns with the first stator magnet ring and the first portion of the rotor magnet ring aligns with the second stator magnet ring, the second rotational position being about 180 degrees from the first rotational position.

6. The orbital magnetic gear of claim 1, wherein the first stator magnet ring comprises a first set of magnets and the second stator magnet ring comprises a second set of magnets, a polarity of each magnet of the first set of magnets being opposite to a polarity of a respective adjacent magnet of the second set of magnets.

7. The orbital magnetic gear of claim 6, wherein the rotor magnet ring comprises a third set of magnets.

8. The orbital magnetic gear of claim 7, wherein each of the first and second sets of magnets have two more poles then the third set of magnets.

9. The orbital magnetic gear of claim 1, further comprising an output drive hub positioned radially within the rotor magnet ring, the rotor magnet ring extending around an outer circumference of the output drive hub.

10. The orbital magnetic gear of claim 9, further comprising a cylindrical bearing surface having an outer surface that is inclined relative to the gear shaft, the cylindrical bearing surface being configured to support the output drive hub such that the rotor magnet ring is canted relative to the gear shaft.

11. The orbital magnetic gear of claim 9, wherein the output drive hub is configured to undergo a wobble motion in response to rotation of the rotor magnet ring about the gear shaft.

12. The orbital magnetic gear of claim 9, wherein the output drive hub comprises one or more spherical sockets, each spherical socket being configured to receive a respective spherical bearing, each spherical bearing having a linear bushing extending outwardly from the spherical bearing.

13. The orbital magnetic gear of claim 1, further comprising one or more stabilizing rings on the gear shaft.

14. A hydroelectric turbine comprising:
a stator;
a rotor disposed radially outward of the stator, the rotor being rotatable around the stator about an axis of rotation;
a generator coupled to the stator; and
an orbital magnetic gear located along the axis of rotation and operably coupled to the generator, the orbital magnetic gear comprising a rotor magnet ring that is canted relative to the axis of rotation; and
a plurality of blades operably coupled to and extending radially outwardly from the orbital magnetic gear, wherein the rotor is rotatable in response to fluid flow interacting with the plurality of blades.

15. The hydroelectric turbine of claim 14, wherein the orbital magnetic gear comprises a gear shaft extending along the axis of rotation, the rotor magnet ring being canted relative to the gear shaft.

16. The hydroelectric turbine of claim 15, further comprising a cylindrical bearing surface, the cylindrical bearing surface having an outer surface inclined relative to the gear shaft, the rotor magnet ring being rotatably coupled to the gear shaft via the cylindrical bearing surface.

17. The hydroelectric turbine of claim 16, wherein the orbital magnetic gear comprises stationary first and second outer magnet rings positioned along the gear shaft, the rotor magnet ring being rotatably coupled to the gear shaft within a space bounded by the stationary first and second outer magnet rings.

18. The hydroelectric turbine of claim 17, wherein the rotor magnet ring is canted relative to the stationary first and second outer magnet rings.

19. The hydroelectric turbine of claim 14, wherein the orbital magnetic gear is configured to provide a low torque, high speed power output to the generator.

20. The hydroelectric turbine of claim 14, wherein the generator is a three-phase, high speed, low torque generator.
